(19) United States
(12) Patent Application Publication
(10) Pub. No.: US 2004/0188870 A1
(43) Pub. Date: Sep. 30, 2004

(54) Method of fabricating a graded index plastics material optical fiber and a preform formation system for implementing a method of the above kind

(76) Inventors: Jerome Fournier, Lyon (FR); David Daboussy, Lyon (FR); Jerome Alric, Lyon (FR); Olivier Pinto, Lyon (FR)

Correspondence Address: SOFER & HAROUN, L.L.P., Suite 910, 317 Madison Avenue, New York, NY, 10017, US

(21) Appl. No.: 10/650,459

(22) Filed: Aug. 27, 2003

(30) Foreign Application Priority Data
Sep. 13, 2002 (FR) 02 11521

(51) Int. Cl. G02B 6/18; B29D 11/00

(52) U.S. Cl. 264/1.24; 425/130; 425/542

(57) ABSTRACT

A method of fabricating a graded index plastics material optical fiber whose refractive index varies between its center and its periphery comprises the following process steps: preparing at least two liquid compositions with different refractive indices, each composition comprising at least one polymer, a substance to vary the refractive index being present in at least one composition and a cross-linking starter being present in at least one composition, filling a preform formation system with the compositions, producing a liquid preform in the system, the refractive index of said preform having a given gradient, and drawing the preform to obtain a graded index plastics material optical fiber. The production of the preform comprises a step with substantially no flow of the compositions along the system.

### BACKGROUND OF THE INVENTION

1. Field of the Invention

The present invention relates to a method of fabricating a graded index plastics material optical fiber and a preform formation system for implementing a method of the above kind.

2. Description of the prior art

Graded index plastics material optical fibers which can be used in a range of the spectrum from visible light to near infrared are beneficial in that they can be applied to broadband access networks.

The fabrication of these plastics material optical fibers is difficult in that it is necessary to control the distribution of the substance or substances so that it varies from the core to the periphery of a plastics material optical fiber to obtain the required index gradient.

The refractive index variation between the center and the periphery of the fiber is from 0.01 to 0.03, for example.

The document EP 1 067 22 A1 describes a method of fabricating a graded index plastics material optical fiber in which the refractive index varies continuously between the center and the periphery.

The method includes:

preparing two compositions with different refractive indices,

filling insulated storage tanks of a mixer system with the compositions,

mixing the compositions in a mixer whose upper portion contains a ball cartridge so as to obtain a graded index liquid preform in the lower portion of the mixer,

reducing the diameter of said preform, which retains a graded index, with the aid of a conical portion extending the lower portion of the mixer,

drawing the reduced diameter preform to obtain a graded index plastics material optical fiber,

cross-linking by optical means to produce a cross-linked three-dimensional array, and

spooling the cross-linked graded index plastics material optical fiber.

The whole of the method is carried out continuously, and in particular the step of mixing the compositions is effected by modifying pressurized flows of the compositions.

The mixing time is not suitable for obtaining a preform with the required index gradient.

A first object of the invention is to provide a method of fabricating continuously graded index optical fibers or discontinuously graded index (stepped index) optical fibers that achieves better control of the required index gradient.

### SUMMARY OF THE INVENTION

To this end, the present invention proposes a method of fabricating a graded index plastics material optical fiber whose refractive index varies between its center and its periphery, the method comprising the following process steps:

preparing at least two liquid compositions with different refractive indices, each composition comprising at least one polymer, a substance adapted to vary the refractive index being present in at least one of the compositions and a cross-linking starter being present in at least one of the compositions,

filling a preform formation system with the compositions,

producing a liquid preform in the system, the refractive index of the preform having a given gradient, and

drawing the preform to obtain a graded index plastics material optical fiber, in which method the production of the preform comprises a step with substantially no flow of the compositions along the system.

According to the invention, the preform can be produced without stresses that are present in the prior art continuous method and are related to the flow of the compositions. By eliminating the correlation between the rate at which the preform is produced and the rate at which it is drawn, the invention eliminates the constraints on the maximum production time of the preform.

Thus the invention consists in separating the production of a liquid preform (in other words a column) from drawing it, for example by dissociating them temporally.

The invention offers great flexibility in the production of the fiber. The liquid preform method is very easy and very quick to use. The method adapts the phase upstream of drawing to the structure of the required fiber (SI, GI, complex profiles) without modifying the drawing tools. The production time of the preform can be adjusted as a function of the characteristics of the compositions chosen (structure, viscosity, etc.), the temperature of the system, and the nature of the interactions between the compositions and the kinetics of those interactions.

The liquid preform can be produced partly or totally in a chemical laboratory, following a distillation phase and in a perfectly controlled manner (controlled atmosphere, zero pollution, optical purity, etc.) to guarantee very high purity.

Moreover, the technique of producing the fiber according to the invention can be adapted to suit a wide variety of compositions without requiring prior development.

A liquid preform is much easier to produce than a solid preform produced by extrusion or by melting granules or rods.

The index gradient can be discontinuous (stepped index) or continuous (with a linear, hyperbolic or any other profile).

In a first embodiment of the method according to the invention, said step with substantially no flow includes a step of obtaining a diameter of the preform compatible with said drawing.

By diameter compatible with said drawing is meant a diameter up to approximately 20 to 30 times greater than the required diameter of the finished fiber.

This embodiment is carried out, for example, using a preform formation system having a cylindrical portion leading to a smaller diameter conical output portion, the system being such that the preform is obtained over the whole of the length of the system. The die can have a section that is straight or reduced at the outlet.

In a second embodiment of the method according to the invention, the production of the preform includes said step substantially without flow followed by a step of obtaining a radial dimension of the preform compatible with said drawing.

A method of this kind corresponds to a situation in which a constant section preform formation system is used, for example. In this configuration, the system produces a preform whose index has the required type of gradient. Once the preform has been produced, the system is disposed on an attached part integrating a die at the outlet, for example, for instance a conical part.

In one embodiment of the method according to the invention, during filling, the compositions are separated in the preform formation system and the production of the discontinuously graded index (stepped index) preform includes bringing the compositions into contact.

After this filling, several actions can produce a continuously graded index preform.

It is in particular possible to apply diverse methods to obtain a continuous concentration gradient of the chemicals between the center and the periphery of the preform, this concentration gradient being reflected in a refractive index gradient.

Also, and advantageously, the production of the continuous graded index preform can preferably include changing the distribution between the center and the periphery of the preform of at least one of the constituents of at least one of the compositions by mechanical treatment preferably chosen from rotation and vibration.

Rotation can accelerate interdiffusion of the compositions. Vibration, for example by emitting ultrasound into the medium, generates molecular displacements. There is then obtained a liquid preform in which the radial distribution (or the structure) of the various compositions is controlled over the whole of its length in order to correspond to an ad hoc continuous index gradient in the finished fiber.

To achieve dynamic flow of the preform, drawing can be preceded by pressurizing said system, either by injecting a compressed neutral gas into the preform formation system or by actuating a piston in the preform formation system.

The invention also aims to provide equipment for implementing a method of fabricating a continuously graded index optical fiber or a discontinuously graded index (stepped index) optical fiber achieving improved control over the required index gradient.

To this end, the invention proposes a preform formation system for implementing the method as described previously of fabricating a graded index plastics material optical fiber, said system containing a first area for isolating the compositions during said filling and a second area for formation of the graded index preform, which system is characterized in that the first area and the second area have at least one common portion.

The preform formation system can advantageously comprise as many concentric enclosures of given axis and given internal dimensions as there are compositions to be injected, the external enclosure being extended axially by a member with varying internal dimensions and the internal enclosure(s) being removable and longer than the external enclosure.

The preform formation system can include means for applying mechanical treatment to the compositions chosen from vibration means and rotation means.

The vibration means can comprise an ultrasound transducer connected to a probe.

The preform formation system can include a drawing member which receives axially said member with varying internal dimensions, and said drawing member can contain a removable closure member.

The invention will be better understood and other features and advantages will become apparent on reading the following description, which is given by way of nonlimiting example and with reference to FIGS. 1 to 3. In the figures, common elements carry the same reference numbers.

### BRIEF DESCRIPTION OF THE DRAWINGS

FIG. 1 is a diagrammatic view in section of a first stepped index preform formation and drawing system using a first embodiment of the method according to the invention.

FIG. 2 is a diagrammatic view in section of a second continuous graded index preform formation and drawing system using a second embodiment of the method according to the invention.

FIG. 3 is a diagrammatic view of the members used after drawing in the implementation of the method of fabricating a graded index plastics material optical fiber.

### DETAILED DESCRIPTION OF THE PREFERRED EMBODIMENTS

The method according to the invention includes the preparation of two liquid compositions (the preparation means are not shown) each comprising, for example, the same polymer P preferably containing at least one reactive functional group and the same compound(s) M1, M2, respectively, which are preferably monomers each containing at least one reactive functional group, the substances M1 and M2 having different refractive indices.

The concentrations of the substances Ml and/or M2 in each composition are different, which gives each composition a different refractive index. The refractive index difference between the core and cladding compositions is from 0.01 to 0.03, for example.

The first composition, called the core composition, has a higher refractive index. The second composition, called the cladding composition, has a lower refractive index. A reticulation starter, for example of the photostarter type, is incorporated into at least one of said compositions.

For the preparation method and the choice of core and cladding compositions see examples 1, 2 and 4 of the prior art application previously cited for the two embodiments described hereinafter.

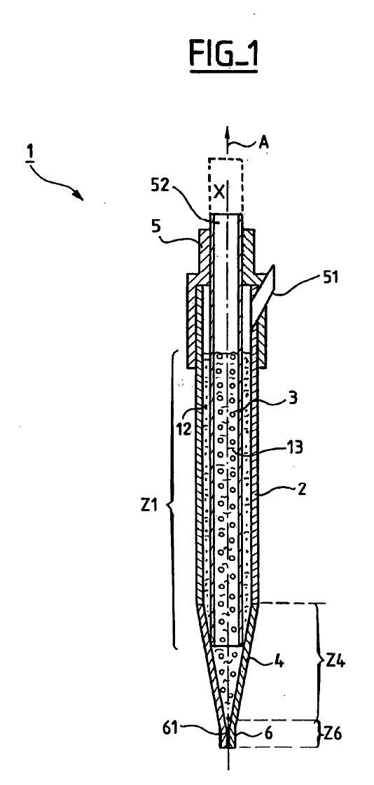

FIG. 1 is a diagrammatic view in section, in an axial plane X, of a first system 1 for forming and drawing a preform, for example a stepped index preform, using a first embodiment of the method according to the invention.

The first system 1 includes two concentric tubes 2, 3 with the same central axis X. The 45 mm diameter and 200 mm long external tube 2 is extended axially by a conical member 4 with an outlet diameter substantially equal to 2.5 mm. The removable 32 mm diameter central tube 3 is more than 200 mm long and rests on the walls of the conical member 4.

The first system 1 further includes a sealed upper closure 5 which includes an inlet 51 discharging laterally onto the external tube 2 for injecting the cladding composition. A central wall 52 of the closure 5 enables placement or withdrawal of the central tube 3.

Furthermore, means (not shown) at the level of the central bore, such as compressed neutral gas injection means or a piston, produce a controlled pressure in the system.

In this example, the first system 1 further includes a 2.5 mm diameter 15 mm long die 6 with central axis X receiving the conical member 4. The die 6 defines a calibrated area Z6 which gives the required order of magnitude of the diameter of the graded index optical fiber obtained. The die 6 contains a removable closure member 61.

In a variant, the die 6 is an attached part, which means that calibration can be changed easily without changing the system.

The steps of the method are described next.

During the filling phase, the die 6 is shut off, the external tube 2 serves as a storage tank for the cladding composition 12, and the higher refractive index core composition 13 is placed in the central tube 3 and the conical member 5.

Withdrawing the central tube 3 in the direction of the arrow A (as symbolically represented in dashed outline) brings the compositions 12, 13 into contact and thus form a liquid preform (not shown) whose index features the required step. The area Z1 initially reserved for isolating the compositions then corresponds to the area of formation of the stepped index preform. According to the invention, the preform is obtained with no flow of the core and cladding compositions along the system 1, with the result that the rate at which the preform is produced no longer depends on the drawing rate. In this sense the method according to the invention is discontinuous.

After withdrawing the closure member 61 and the controlled application of pressure to the system 1, typically a pressure from 0.5 bar to 5 bar, the liquid preform (not shown) flows along the axis X into the area Z4 of the conical member 4 and is thus brought to the calibrated die 6. The preform is subjected in this area to a variation of its diameter to a diameter compatible with drawing, subject to a condition of geometrical similarity, i.e. without modifying the relative size of its various portions, and retaining a discontinuously graded (i.e. stepped) refractive index.

In a variant that is not shown, a cryogenic cooling system can be placed around the conical member 4, in which the preform flows toward the die 6. This progressively increases the viscosity of the preform to a value greater than 50 Pa.s, producing a relatively thick liquid so that it flows more slowly. The viscosity in the die 6 is from 1 to 5 Pa.s.

In another variant that is not shown, the system 1 is modified to include an additional removable tube with axis X to obtain a fiber with multiple index steps.

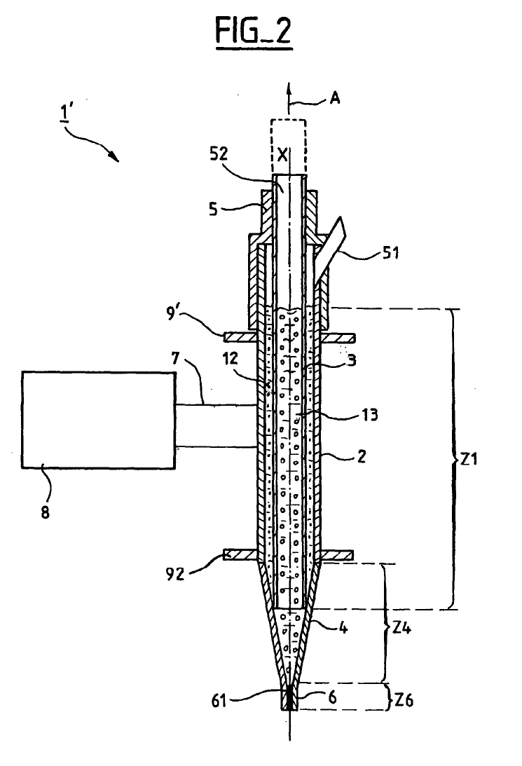

FIG. 2 is a diagrammatic view in section in an axial plane X of a second system 1′ for forming and drawing a preform, for example one with a continuously graded index, using a second embodiment of the method according to the invention.

In a similar manner to the first system, the second system 1′ includes, along the same central axis X, a sealed upper closure 5, two concentric tubes 2, 3, and a conical member 4 followed by a die 6 containing a removable closure member 61. The closure 5 includes an inlet 51 and a central bore 52, the inlet 51 discharging laterally onto the external tube 2.

Similarly, means (not shown) in the central bore, such as compressed neutral gas injection means or a piston, produce a controlled pressure in the system 1′.

The area Z1 isolates the core and cladding compositions 12, 13 during filling.

The die 6 defines a calibrated area Z6 which gives the required order of magnitude of the diameter of the graded index optical fiber obtained.

The second system 1′ further includes a probe 7 for transmitting mechanical vibrations at an ultrasound frequency of the order of 20 000 Hz. The probe 7 is caused to vibrate by a transducer 8 for transforming electrical energy into mechanical vibrations.

During the filling phase, the external tube 2 serves as a storage tank for the cladding composition 12, while the higher refractive index core composition 13 is placed in the central tube 3 and the conical member 5.

By withdrawing the central tube 3 in the direction of the arrow A (as symbolized in dashed outline), the compositions 12, 13 are brought into contact and form a liquid preform (not shown) having a particular distribution of the compositions.

Starting the transducer 8 and the probe 7 generates ultrasonic vibration of the cladding and core compositions 12, 13, modifying their radial distributions over the whole of the area Z1, which becomes the area of formation of a continuously graded index preform. Moreover, decoupling members 91, 92 disposed around the external tube 2 limit its vibrations. In accordance with the invention, the preform is obtained with no flow of the core and cladding compositions along the system 1′. By adjusting the preform production time, this produces a better controlled gradient.

After withdrawing the closure member 61 and applying a controlled pressure, typically a pressure from 0.5 bar to 5 bar, to the second system 1′, the preform (not shown) flows into the area Z4 of the conical member 4 until it reaches the die 6. The variation in the concentration of the compositions is preserved in the smaller diameter preform.

In a variant, to obtain during filling the required viscosity of the compositions, which is from 1 to 5 Pa.s, for example, the core and cladding compositions 13, 12 can be heated by placing heat insulating members (not shown) around the external tube 2 and the central tube 3. This facilitates implementing the method according to the invention because this range of viscosity gives relatively fluid compositions, responding better to ultrasound vibration.

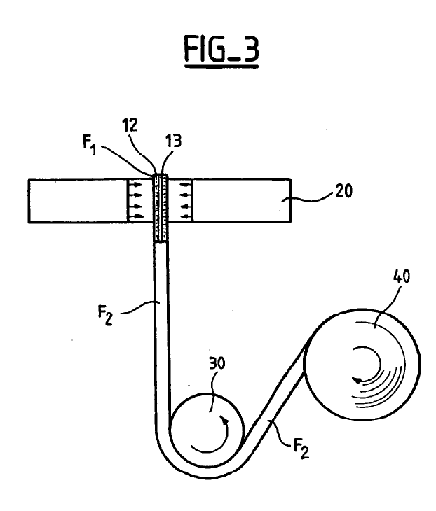

FIG. 3 is a diagrammatic view of members for implementing the method of fabricating a gradient index plastics material optical fiber used after drawing in accordance with the first or second embodiment.

These members are an ultraviolet (UV) source 20, a capstan 30, and a spool 40.

At the exit of the die there is obtained a graded index plastics material optical fiber F, hardened by cross-linking it by means of the UV source 20 to yield a plastics material optical fiber F₂ having a cross-linked structure. The plastics material optical fiber is then wound onto the spool 40 by means of the capstan 30. The diameter of the fiber is set by the die, but can be refined according to the traction force applied by means of the capstan. Either of the plastics material optical fibers F₁ or F₂ can be the finished product of the method according to the invention.

Cross-linking has the advantage that it fixes almost completely the components of the plastics material optical fiber and therefore ensures improved physical and thermal stability of the plastics material optical fiber obtained and the index gradient.

The cross-linking starter, which is a photostarter, for example, is a composition which initiates the required cross-linking reaction, for example thermally or by radiation.

The cross-linking process can also be chosen from electron bombardment and heat treatment.

The plastics material optical fiber obtained by the method of the invention has the advantage that it can be used in a spectral range from visible light to the near infrared, whilst having a low attenuation (less than 1 dB/m) over the whole of the range.

Another advantage of the optical fiber obtained by the method of the invention is that it can be used at high temperatures (up to at least 125° C), because of the nature of the material from which it is made and the thermal stability resulting from its cross-linked structure.

The diameter of the fiber obtained is generally from 100 μm to 1 mm.

Of course, the method in accordance with the invention of fabricating a plastics material optical fiber is not limited to the representations and to the examples described hereinabove. For example, in a variant, at least one coating layer can be deposited onto one of the plastics material optical fibers previously obtained in order to protect it from the exterior environment and to increase its mechanical strength.

According to the invention, the step of forming the required index gradient and the step of reducing the diameter of the graded index preform can also be carried out simultaneously and without flow, i.e. without continuous drawing.

There is claimed:

1. A method of fabricating a graded index plastics material optical fiber whose refractive index varies between its center and its periphery, said method comprising the following process steps:
preparing at least two liquid compositions with different refractive indices, each composition comprising at least one polymer, a substance adapted to vary the refractive index being present in at least one of said compositions and a cross-linking starter being present in at least one of said compositions;
filling a preform formation system with said compositions;
producing a liquid preform in said system, the refractive index of said preform having a given gradient; and
drawing said preform to obtain a graded index plastics material optical fiber in which method the production of the preform comprises a step with substantially no flow of said compositions along said system.

2. The method claimed in claim 1, of fabricating a graded index plastics material optical fiber, wherein said step with substantially no flow includes a step of obtaining a diameter of the preform compatible with said drawing.

3. The method claimed in claim 1, of fabricating a graded index plastics material optical fiber, wherein the production of said preform includes said step substantially without flow followed by a step of obtaining a radial dimension of said preform compatible with said drawing.

4. The method claimed in claim 1, of fabricating-a graded index plastics material optical fiber, wherein said filling step is such that said compositions are separated in said preform formation system and the production of said discontinuously graded index (stepped index) preform includes bringing said compositions into contact.

5. The method claimed in claim 1, of fabricating a graded index plastics material optical fiber, wherein the production of said continuously graded index preform includes changing the distribution between the center and the periphery of said preform of at least one of the constituents of at least one of said compositions by mechanical treatment preferably chosen from rotation and vibration.

6. The method claimed in claim 1, of fabricating a graded index plastics material optical fiber, wherein drawing is preceded by controlled pressurization of said preform formation system either by injecting a compressed neutral gas into said system or by actuating a piston in said system.

7. A preform formation system for implementing a method as claimed in claim 1, of fabricating a graded index plastics material optical fiber, said system containing a first area for isolating said compositions during said filling and a second area for formation of said graded index preform, in which system said first area and said second area have at least one common portion.

8. The preform formation system claimed in claim 7, comprising as many concentric enclosures of given axis and given internal dimensions as there are compositions to be injected, the external enclosure being extended axially by a member with varying internal dimensions and the internal enclosure(s) being removable and longer than said external enclosure.

9. The preform formation system claimed in claim 7, comprising means for applying mechanical treatment to said compositions chosen from vibration means and rotation means.

10. The preform formation system claimed in claim 9, wherein said vibration means comprise an ultrasound transducer connected to a probe.

11. The preform formation system claimed in claim 7, comprising as many concentric enclosures with a given axis and given internal dimensions as there are compositions to be injected, the external enclosure being extended axially by a member with varying internal dimensions and the internal enclosure(s) being removable and longer than said external enclosure, and a drawing member which receives axially said member with varying internal dimensions and contains a removable closure member.
